(19) United States
(12) Patent Application Publication
(10) Pub. No.: US 2020/0136809 A1
(43) Pub. Date: Apr. 30, 2020

(54) SYSTEMS AND METHODS FOR DECENTRALIZED DISTRIBUTED STORAGE USING BLOCKCHAIN

(71) Applicants: XANADU BIG DATA, LLC, Lexington, MA (US); HashBlock Inc., Seoul (KR)

(72) Inventors: Rhys Andrew Newman, Perth (AU); Alex Geunho Lee, Lexington, MA (US)

(73) Assignees: Xanadu Big Data, LLC; HashBlock Inc.

(21) Appl. No.: 16/453,217

(22) Filed: Jun. 26, 2019

Related U.S. Application Data
(60) Provisional application No. 62/752,911, filed on Oct. 30, 2018.

(51) Int. Cl. H04L 9/06; H04L 9/08; H04L 9/32; G06F 16/182

(52) U.S. Cl. CPC H04L 9/0643; H04L 9/0869; H04L 9/3271; H04L 2209/38; H04L 9/0618; H04L 9/0894; G06F 16/1824

(57) ABSTRACT

Disclosed is a decentralized distributed storage system comprises a storage protocol module, validation protocol module, and retrieval protocol module. The storage protocol module enables a client to perform a first plurality of steps to store data in a data storage unit deployed by a provider. The validation protocol module enables the client to place a storage challenge on a storage token chain. The provider identifies the storage challenge on the storage token chain and performs a second plurality of steps to validate the storage challenge. The storage token chain comprises storage tokens transmitted from the client to the provider on detecting a validation of the placed challenge or returned to the client on detection of non-validation. The retrieval protocol module enables the client to perform a third plurality of steps to access the data storage unit to retrieve the stored data by providing storage tokens to the provider.

### CROSS-REFERENCE TO RELATED APPLICATIONS

This application claims the benefit of U.S. Provisional Application No. 62/752,911, filed Oct. 30, 2018. The entire content of that application is hereby incorporated herein by reference.

### FIELD

The present disclosure generally relates to the field of the decentralized distributed storage system, and in particular, the present disclosure relates to systems and methods for decentralized distributed data storage using blockchain.

### BACKGROUND

Typically, centralized databases are located, maintained, and placed in a single location. To access the stored data on the centralized database, the user or client has to connect to a server, which is the main computer of the centralized database. The centralized databases require regular temperature control, periodic updating, and rigorous maintenance. The technologies needed to carry out these tasks are not only expensive but also require to be refreshed or replaced regularly. Further, the safety of the stored data in the current centralized database is a major problem. The providers design their privacy policies in a way that still allows them to access and share the client's data legally. Additionally, hackers also can access non-encrypted files in centralized databases.

Therefore, there is a need for a decentralized distributed storage system to mitigate the issues of security, privacy, speed, hacks, or power shortages that affect the centralized databases. Further, there is a requirement for a system and method for managing distributed data storage by establishing a trusted and decentralized peer-to-peer network.

### SUMMARY

In one aspect of the present disclosure, there is provided a method for storing data in a data storage unit. The method includes performing in a client device, a first plurality of steps to store a block of data in the data storage unit. The first plurality of steps include, selecting a random seed for initializing a secure random number generator, computing a secure hash of the block of data to be stored by utilizing a plurality of bytes at one or more addresses specified by a series of numbers from an output of the random number generator and storing the secure hash of the block of data and the random seed. The steps of selecting the random seed, computing the secure hash of the block and storing resultant secure hash of the block of data and initial random seed are repeated plurality of times. Further, the block of data together with a secret key and the computed secure hash and the random seed pairs are transmitted to a provider device.

In the provider device, a second plurality of steps are performed to validate a storage challenge identified on a storage token (ST) chain by the provider device. The second plurality of steps include initializing an identical random number generator by using the random seed. Further, computing the secure hash of the stored data sent by the client device and placing the computed secure hash of the block of data on the ST chain for verification.

The storage challenge identified on the ST chain is verified on matching secure hash of a unique identification number of the provider device with stored secure hash of data sent by the client device. The ST chain transmits a plurality of storage tokens listed in the storage challenge to the provider device on verification of the storage challenge. Further, the storage tokens are returned by the ST chain to the client device on non-verification of the storage challenge.

Another embodiment of the present disclosure provides a method for accessing a data storage unit for retrieving stored data. The method includes performing in a client device, a plurality of steps to access the data storage unit to retrieve the stored data by providing storage tokens. The plurality of steps include initiating in the client device, a request for accessing a block of data by transmitting a secure hash of the block of data together with a secret key registered when the block of data was stored in the data storage unit. The received secure hash of the block of data and the secret key are verified in the provider device. On verification, the provider device sends the block of data encrypted with a new secret key to the client device. Then, a secure hash of the encrypted block of data is computed and the computed secure hash is placed with a sum of a plurality of storage tokens on a ST chain by the client device. In the provider device, a responding block on the ST chain is placed to hold the secure hash of the block of data with the new secret key to decrypt the data. Further, in the client device, the new secret key that the provider device used to encrypt the block of data is retrieved. The block of data is decrypted in the client device and the storage tokens are transferred from the client device to the provider device.

The ST chain executes a plurality of functionalities at a predefined rate to ensure timely performance and prevent denial of one or more service attacks. Further, consistency of transactions for one or more double-spend attempts is determined and one or more new blocks are added to the ST chain. The blocks are time stamped by an externally verifiable source.

In another aspect of the present disclosure, there is provided a data storage management system for storing data in a data storage unit. The data storage management system includes a client device configured to store a block of data in the data storage unit. The client device includes a selection module configured to select a random seed to initialize a secure random number generator. Further, the client device includes a computing module configured to compute a secure hash of the block of data to be stored by utilizing a plurality of bytes at one or more addresses specified by a series of numbers from an output of the random number generator. The client device also includes a storage module configured to store the secure hash of the block of data and the random seed, and a transmission module configured to transmit the block of data together with a secret key and the secure hash and the random seed pair to a provider device. The provider device is configured to validate a storage challenge identified on a ST chain. The provider device includes an initializing module configured to initialize an identical random number generator by using the random seed. Further, the provider device includes a computing module configured to compute the secure hash of the stored data sent by the client device and a verification module configured to place the computed secure hash of the block of data on the ST chain for verification.

In the data storage management system, the storage challenge identified on the ST chain is verified on matching secure hash of a unique identification number of the provider device together with stored secure hash of data sent by the client device. The ST chain transmits a plurality of storage tokens listed in the storage challenge to the provider device on verification of the storage challenge. Further, the ST chain returns the storage tokens to the client device on non-verification of the storage challenge.

In yet another aspect of the present disclosure, there is provided a data storage management system for accessing a data storage unit for retrieving stored data. The data storage management system includes an initializing module configured to initiate, in the client device, a request for accessing a block of data by transmitting a secure hash of the block of data together with a secret key registered when the block of data was stored in the data storage unit. The system includes a verification module configured to verify, in a provider device, the received secure hash of the block of data and the secret key. The system also includes a transmission module configured to send, from the provider device to the client device, the block of data encrypted with a new secret key. Further, the data storage management system includes a computing module configured to compute, in the client device, a secure hash of the encrypted block of data and placing the computed secure hash with a sum of a plurality of storage tokens on a ST chain. The system includes a placement module configured to place, in the provider device, a responding block on the ST chain to hold the secure hash of the block of data with the new secret key to decrypt the data. Further, the system includes a retrieval module configured to retrieve, in the client device, the new secret key that the provider device used to encrypt the block of data sent from the client device. The system includes a decryption module configured to decrypt the block of data in the client device and a transferring module configured to transfer the storage tokens from the client device to the provider device.

The ST chain executes a plurality of functionalities at a predefined rate to ensure timely performance and prevent denial of one or more service attacks. Further, the data storage management system includes a determination module configured to determine consistency of transactions for one or more double-spend attempts and adding a one or more new blocks to the ST chain. The blocks are time stamped by an externally verifiable source.

### BRIEF DESCRIPTION OF DRAWINGS

This disclosure will be more fully understood from the following detailed description taken in conjunction with the accompanying drawings, in which:

FIG. 1 illustrates an exemplary block diagram of a decentralized distributed storage system, according to an example embodiment of the present disclosure.

FIG. 2 illustrates a method flowchart for storing data in a data storage unit, according to some embodiments of the present disclosure.

FIG. 3 illustrates a method flowchart for validating the storage challenge, according to some embodiments of the present disclosure.

FIG. 4 illustrates a method flowchart for accessing the data storage unit for retrieving the stored data by providing storage tokens to the provider, according to some embodiments of the present disclosure.

### DETAILED DESCRIPTION

The present disclosure will now be described more fully with reference to the accompanying drawings, in which embodiments of the present disclosure are shown. However, this disclosure should not be construed as limited to the embodiments set forth herein. Rather, these embodiments are provided so that this disclosure will be thorough and complete, and will fully convey the scope of the present disclosure to those skilled in the art. In the present disclosure, like-numbered components of various embodiments generally have similar features when those components are of a similar nature and/or serve a similar purpose.

The present disclosure is implemented in the context of a system for decentralized distributed data storage. The present system can use state of the art distributed and fault-tolerant agreement algorithms known to those of skill in the art, and therefore can execute distributed transactions with Atomicity, Consistency, Isolation, and Durability (ACID) semantics.

The present disclosure discloses system and method for decentralized distributed data storage using blockchain whereby stored data are not connected to a data storage unit, and instead, the data are located on different and independent data storage units in the same location or spread across networks of interconnected computers. Each node that contains information has its own set of data and equal rights. If a single node is compromised, the network can continue to update and operate.

For easy understanding of the present disclosure, a few terms that are used in the description are defined or discussed without limiting the scope of the terms. The term “client” refers to any person or organization who wants to store the data in a data storage unit provided the providers, and to retrieve data promptly. The term “provider” represents any organization/entity/person who offers to store the data on behalf of the client and allow the retrieval of the data promptly. The term “storage token” represents a cryptocurrency provided to the providers as an incentive for performing various operations, such as storing and retrieving data on behalf of the clients.

Storage media that can be used for the data storage includes volatile and non-volatile, removable and non-removable media implemented in any method or technology for storage of information. Storage media can include memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid-state devices (e.g., solid-state drive (SSD), flash memory drive (e.g., card, stick, key drive)), or any other like medium which can be used to store the desired data.

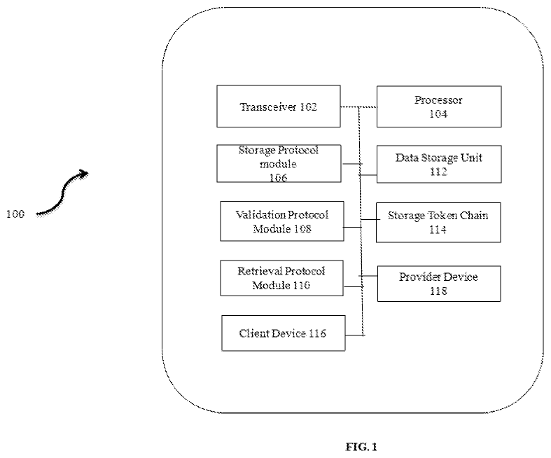

FIG. 1 illustrates an exemplary block diagram of a decentralized distributed storage system 100, according to an example embodiment of the present disclosure. The decentralized distributed storage system 100 comprises a transceiver 102, a processor 104, a storage protocol module 106, a validation protocol module 108, a retrieval protocol module 110, a data storage unit 112, a storage token (ST) chain 114, a client device 116, and a provider device 118. Each of the components 102-118 may be implemented in a single computing device or multiple computing devices connected via a communication bus using known or later developed technology.

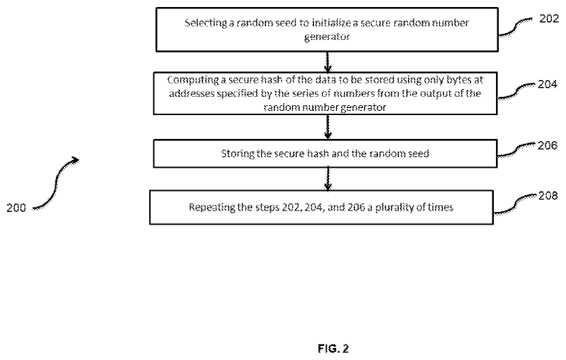

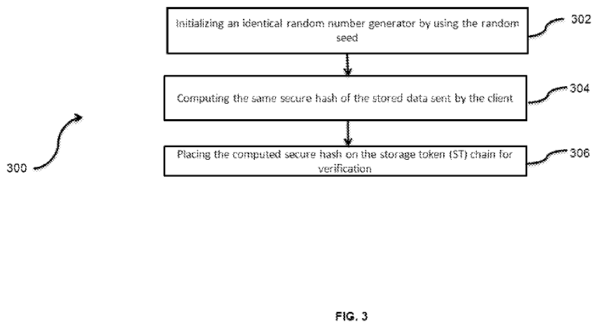

The storage protocol module 106 is configured with the processor 104 to enable a client to perform a first plurality of steps (shown and explained in conjunction with FIG. 2) through a client device 116 to store data in a data storage unit 112 deployed by a provider. The validation protocol module 108 is configured with the processor 104 to enable the client to place a storage challenge on a storage token chain 114. The provider identifies the storage challenge on the ST chain 114 and performs a second plurality of steps (shown and explained in conjunction with FIG. 3) through a provider device 118 to validate the storage challenge. Various examples of the client device 116 and provider device 118 include, but not limited to, such as cell phones, personal digital assistants (PDAs), computers, servers, laptop computers, tablets, Internet appliances, and the like.

The ST chain 114 comprises a plurality of storage tokens. The storage tokens are transmitted from the client device 116 to the provider device 118 on detecting a validation of the placed challenge or returned to the client device 116 on detection of non-validation of the placed challenge. The storage token is a cryptocurrency provided to the providers as an incentive for performing various operations, such as storing and retrieving data on behalf of the clients. These storage tokens are stored “on the chain” and if the challenge is not successful they are returned to the client's ownership (still on the chain though) rather than “returned to the client device”.

In an embodiment, the present decentralized distributed storage system 100 assigns one or more unique identification numbers corresponding to each client, and thus client device, and provider, and thus provider device so that the client and the provider can connect over a communication network (not shown). Further, the ST chain 114 stores a value against each unique identification numbers on a public distributed blockchain. In an implementation, the public distributed blockchain is managed by a plurality of storage token consortium servers. The ST chain 114 manages the public shared state of administrative operations, mediated by the ownership and transfer of storage tokens, but does not store the data directly.

The validation detection or non-validation detection may be received by the ST chain 114, via the transceiver 102. The placed challenge comprises a random seed from the storage protocol module 106, a hash value of an identification number of the provider with a corresponding secure hash value of the stored data.

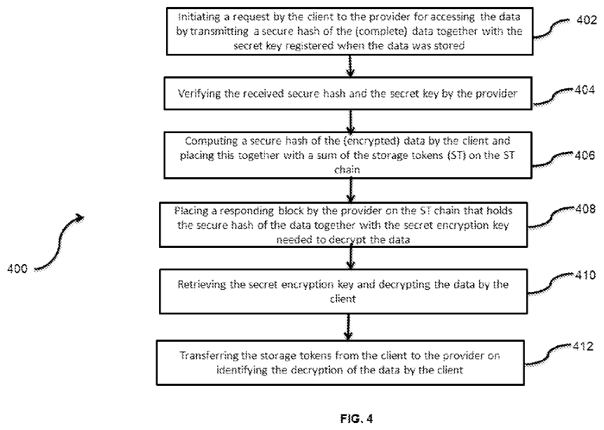

The retrieval protocol module 110 is configured with the processor 104 to enable the client to perform a third plurality of steps (shown and explained in conjunction with FIG. 4) through the client device 116 to access the data storage unit 112 to retrieve the stored data by providing storage tokens to the provider.

In some implementations, one or more data storage unit 112, the client device 116 and the provider device 118 may be communicatively coupled via a communication network (not shown) that may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof. The communication network may be any other type of network that is capable of transmitting or receiving data to/from host computers, storage devices, personal devices, telephones, video/image capturing devices, video/image servers, or any other electronic devices. Further, the communication network is capable of transmitting/sending data between the mentioned devices.

Additionally, the communication network may be a local, regional, or global communication network, for example, an enterprise telecommunication network, the Internet, a global mobile communication network, or any combination of similar networks. The communication network may be a combination of an enterprise network (or the Internet) and a cellular network, in which case, suitable systems and methods are employed to seamlessly communicate between the two communication networks. In such cases, a mobile switching gateway may be utilized to communicate with a computer network gateway to pass data between the two communication networks. The communication network may include any software, hardware, or computer applications that can provide a medium to exchange signals or data in any of the formats known in the art, related art, or developed later.

Accordingly, one advantage of the present decentralized distributed storage system 100 is that it comprises a self-healing p2p (pear to pear) distributed storage network while automatically detecting and repairing failures of the data storage unit 112. This is just an inherent property of decentralized storage—i.e. there will be multiple copies of any data stored and thus a very low chance all copies become unavailable at the same time. Auto-healing in this context is helpful in the face of failures and would only be available in some distributed systems

Accordingly, one advantage of the present decentralized distributed storage system 100 is that it stores a plurality of copies of the same data (replicas) over several independent data storage units 112 to tolerate failures of some data storage units. In an embodiment, the present decentralized distributed storage system 100 allows the client or the provider to select the one or more replication factors.

Accordingly, key advantage of the present decentralized distributed storage system 100 is that it utilizes a deduplication-friendly content-based encryption technique to enable global deduplication while maintaining the security of the stored data. Further, the stored data is compressed to save the storage space of the data storage units 112.

FIG. 2 illustrates a method flowchart 200 for storing data in a data storage unit, according to some embodiments of the present disclosure. FIG. 2 is explained in conjunction with FIG. 1. The storage protocol module 106 enables the client to perform a first plurality of steps through a client device 116 to store data in a data storage unit 112 deployed by a provider. The first plurality of steps comprises a step 202 of selecting a random seed to initialize a secure random number generator. The first plurality of steps further comprises a step 204 of computing a secure hash of the data to be stored using only bytes at addresses specified by the series of numbers from the output of the random number generator.

Further, the first plurality of steps comprises a step 206 of storing the secure hash and the random seed. The first plurality of steps then comprises a step 208 of repeating the steps 202, 204, and 206 a plurality of times. The client device 116 transmits the data to the provider device 118 together with a secret key and the secure hash and the random seed pairs computed in the steps 202, 204 and 206. The provider device 118 authorizes the client device 116 through the received secret key and allows the client to retrieve the data from the data storage unit 112, and retains the secure hash and the random seed pairs computed in the steps 202, 204 and 206.

FIG. 3 illustrates a method flowchart 300 for validating the storage challenge, according to some embodiments of the present disclosure. FIG. 3 is explained in conjunction with FIG. 1. The provider identifies the storage challenge on the ST chain 114 and performs a second plurality of steps through a provider device 118 to validate the storage challenge. The second plurality of steps comprises a step 302 of initializing an identical random number generator by using the random seed. The second plurality of steps then comprises a step 304 of computing the same secure hash (as explained in FIG. 2) of the stored data sent by the client. Further, the second plurality of steps comprises a step 306 of placing the computed secure hash on the ST chain for verification.

In operation, if the secure hash of the provider's unique identification number together with the submitted secure hash matches that supplied by the client the placed challenge is successful. The only way the provider could get this result correct is if it had indeed stored the data the client originally sent, so the ST chain transfers the storage tokens listed in the placed challenge into the provider's ownership. At this point, the client is assured, securely, that the provider does indeed still hold their data as required. If the provider's supplied secure hash does not match the client's secure hash, the ST chain returns the storage tokens to the client's ownership. At this point, the client knows the provider does not retain their data and so needs to react accordingly.

Typically, in a scenario of distributed storage systems, the clients have valuable data stored in multiple locations/providers, and the loss of one copy is not an unexpected disaster. Since the unique identification numbers of the providers are known to the clients, the clients may choose not to use a particular provider again, which gives providers an incentive to hold data reliably. In the present decentralized distributed storage system, the clients need to place challenges at regular intervals with non-trivial storage token rewards so that providers can earn the storage tokens in response to the placed challenges. Thus the clients who neglect to do this often enough (or provide small storage token amounts) will not be attractive clients to providers, and so providers will likely delete their data in favor of the clients who place more valuable challenges. It will lead to a self-regulating system for the clients and the providers to store and manage the most valuable data in a globally efficient way.

In an exemplary embodiment, the client may need to provide an additional incentive to the provider to retrieve the data. Although some providers may not require the additional incentive and earn the rewards merely from the challenges mentioned in FIG. 3.

FIG. 4 illustrates a method flowchart 400 for accessing the data storage unit for retrieving the stored data by providing storage tokens to the provider, according to some embodiments of the present disclosure. FIG. 4 is explained in conjunction with FIG. 1. The retrieval protocol module 110 enables the client to perform a third plurality of steps through the client device 116 to access the data storage unit 112 to retrieve the stored data by providing storage tokens to the provider. The third plurality of steps comprises a step 402 of initiating a request by the client to the provider for accessing the data by transmitting a secure hash of the (complete) data together with the secret key registered when the data was stored. The third plurality of steps then comprises a step 404 of verifying the received secure hash and the secret key by the provider. If it matches, the provider sends the data back to the client encrypted with a (new) secret key different from the received secret key known only to the provider.

Further, the third plurality of steps comprises a step 406 of computing a secure hash of the (encrypted) data by the client and placing this together with a sum of the storage tokens on the ST chain. The third plurality of steps comprises a step 408 of placing a responding block by the provider on the ST chain that holds the secure hash of the data together with the secret encryption key needed to decrypt the data. Furthermore, the third plurality of steps comprises a step 410 of retrieving the secret encryption key and decrypting the data by the client. The third plurality of steps comprise a step 412 of transferring the storage tokens from the client to the provider on identifying the decryption of the data by the client. Consequently, storage token ownership is transferred from the client to the provider.

In an exemplary scenario, a bad actor may exploit the retrieval protocol module to gain some storage tokens unfairly. The provider could place an incorrect secret encryption key on the ST chain in step 408, in which case the client cannot decrypt the data but the provider will have received the storage tokens placed by the client in step 406. Because of this the number of storage tokens offered for simple data access should not be substantial, and a provider that behaves badly will get a short-term unfair gain. The client will stop using the services of such providers, however, and if a general reputation for this spreads the provider may lose many other clients too. The provider will, therefore, earn no more storage tokens from the data challenges.

Further, in case, the provider does not respond with the data in step 402, or responds slowly, the provider may receive a bad reputation, and the clients move their data, and associated validation challenges, to alternative providers. As clients should not store data in only one provider, it should always be possible to ensure a copy of the required data is stored with sufficient providers so that one failure does not render the data unrecoverable.

The various functionalities of the ST chain 114 execute at a predefined rate, determined at a predefined time, and fast enough to ensure timely performance but slow enough to moderate the performance and prevent denial of the service attacks. In case, for example, the cycle time of the ST chain 114 is fixed at one minute then every transaction on the ST chain 114 will be time stamped at these intervals and not resolved at a rate any faster than that. Within each minute interval, the ST consortium servers receive posts from the clients and the providers which they batch up ready for validation. At the end of the interval, the consistency of the transactions are checked for double-spend attempts (which if found are excluded), and a new block is added to the ST chain 114 in the conventional blockchain way.

Typically, the forks in the ST chain 114 are avoided by two approaches. Firstly the ST chain 114 is maintained by the Paxos distributed agreement algorithm, and this ensures that multiple blocks are not added simultaneously by accidental submission to different systems. Secondly, the proof of stake can be used to ensure long-term forks do not occur. The providers provide a digitally signed secure hash of the current latest block in the proposed next block to indicate that they agree with the transactions up to that point. With their unique identification numbers associated with a total storage token value, this gives them a weighted vote of validity. Other providers or clients can similarly register their views by signing with their secure keys, and the fork of the chain with the greatest weighted vote of participants is the one that is accepted by all.

The forks on the ST chain 114 result in rearrangements of the ownership of the storage tokens rather than compromise, corrupt or limit access to the data. Consequently, short-term forks can be tolerated as a minor inconvenience, assuming the fiat value of a storage token is not large, so there is no need to aggressively manage voting and signatures in support thereof. Typically, the fork is a situation that occurs when two or more blocks have the same block height.

If required, in the future, the blocks could be time stamped by an externally verifiable source such as a time value derived from a well-known blockchain system like Bitcoin (https://opentimestamps.org/). Secure time stamping can help limit the forking opportunities and bring the risks down to that suffered by even the Bitcoin chain—e.g., the 51% Sybil attack.

The present disclosure may be implemented for any environment having multiple server nodes. The present disclosure may be implemented in a regular client-server configuration, however other configurations may also be implemented.

The method flowcharts or processes described above, and steps thereof, may be realized/executed in hardware, software, or any combination of these suitable for a particular application. The hardware may include a general-purpose computer and/or dedicated computing device. The processes may be realized in one or more microprocessors, microcontrollers, embedded microcontrollers, state machine, programmable digital signal processors or other programmable device, along with internal and/or external memory. The processes may also, or instead, be embodied in a general purpose processor, a digital signal processor (DSP), an application specific integrated circuit, a programmable gate array, programmable array logic, or any other device or combination of devices that may be configured to process electronic signals.

It will further be appreciated that one or more of the processes may be realized as computer executable code created using a structured programming language such as C, an object oriented programming language such as C++/Java, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Computer storage media includes volatile and non-volatile, removable and non-removable media implemented in any method or technology for storage of information such as computer-readable instructions, data structures, program modules, or other data. Computer storage media can include memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid-state devices (e.g., solid-state drive (SSD), flash memory drive (e.g., card, stick, key drive)), or any other like medium which can be used to store the desired information and which can be accessed by the computer.

The decentralized distributed storage system as described in the present disclosure or any of its components may be embodied in the form of a computer system. Typical examples of a computer system include a general-purpose computer, a programmed microprocessor, a micro-controller, a peripheral integrated circuit element, and other devices or arrangements of devices that are capable of implementing the method of the present disclosure.

The computer system comprises a computer, an input device, a display unit, and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN, and the Internet. The computer system facilitates inputs from a user through an input device, accessible to the system through I/O interface.

The computer system executes a set of instructions that are stored in one or more storage elements, to process input data. The storage elements may also hold data or other information as desired. The storage element may be in the form of an information source or a physical memory element present in the processing machine.

The set of instructions may include one or more commands that instruct the processing machine to perform specific tasks that constitute the method of the present disclosure. The set of instructions may be in the form of a software program. Further, the software may be in the form of a collection of separate programs, a program module with a larger program or a portion of a program module, as in the present disclosure. The software may also include modular programming in the form of object-oriented programming. The processing of input data by the processing machine may be in response to user commands, results of previous processing or a request made by another processing machine.

For a person skilled in the art, it is understood that these are exemplary case scenarios and exemplary snapshots discussed for understanding purposes. However, many variations to these can be implemented to detect objects (primarily human bodies) in video/image frames.

In the drawings and specification, there have been disclosed exemplary embodiments of the present disclosure. Although specific terms are employed, they are used in a generic and descriptive sense only and not for purposes of limitation, the scope of the present disclosure being defined by the following claims. Those skilled in the art will recognize that the present disclosure admits of a number of modifications, within the spirit and scope of the inventive concepts, and that it may be applied in numerous applications, only some of which have been described herein. It is intended by the following claims to claim all such modifications and variations which fall within the true scope of the present disclosure.

What is claimed is:

1. A method for storing data in a data storage unit, the method comprising:
performing, in a client device, a first plurality of steps to store a block of data in the data storage unit, wherein the first plurality of steps comprising:
selecting a random seed to initialize a secure random number generator;
computing a secure hash of the block of data to be stored by utilizing a plurality of bytes at one or more addresses specified by a series of numbers from an output of the random number generator;
storing the secure hash of the block of data and the random seed;
repeating, a plurality of times, the steps of selecting the random seed, computing the secure hash of the block of and storing resultant secure hash of the block of data and initial random seed; and
transmitting, to a provider device, the block of data together with a secret key and the secure hash and the random seed pairs computed in the above steps; and
performing, in the provider device, a second plurality of steps to validate a storage challenge identified on a storage token (ST) chain by the provider device, wherein the second plurality of steps comprising:
initializing an identical random number generator by using the random seed;
computing the secure hash of the stored data sent by the client device; and
placing the computed secure hash of the block of data on the storage token (ST) chain for verification.

2. The method as claimed in claim 1, wherein the storage challenge identified on the ST chain is verified on matching secure hash of a unique identification number of the provider device together with stored secure hash of data sent by the client device.

3. The method as claimed in claim 1, wherein the ST chain transmits a plurality of storage tokens listed in the storage challenge into the provider device on verification of the storage challenge.

4. The method as claimed in claim 1, wherein the ST chain returns the storage tokens into the client device on non-verification of the storage challenge.

5. A method for accessing a data storage unit for retrieving stored data, the method comprising:
performing, in a client device, a plurality of steps to access the data storage unit to retrieve the stored data by providing storage tokens, wherein the plurality of steps comprising:
initiating, in the client device, a request for accessing a block of data by transmitting a secure hash of the block of data together with a secret key registered when the block of data was stored in the data storage unit;
verifying, in a provider device, the received secure hash of the block of data and the secret key
sending, in the provider device to the client device, the block of data encrypted with a new secret key
computing, in the client device, a secure hash of the encrypted block of data and placing the computed secure hash with a sum of a plurality of storage tokens on a storage token (ST) chain;
placing, in the provider device, a responding blockon the ST chain to hold the secure hash of the block of data with the new secret key to decrypt the data;
retrieving, in the client device, the new secret key that the provider device used to encrypt the block of data sent from the client device;
decrypting, in the client device, the block of data; and
transferring the storage tokens from the client device to the provider device.

6. The method as claimed in claim 5, wherein the ST chain executes a plurality of functionalities at a predefined rate to ensure timely performance and prevent denial of one or more service attacks.

7. The method as claimed in claim 5 comprises a step of determining consistency of transactions for one or more double-spend attempts and adding a one or more new blocks to the ST chain.

8. The method as claimed in claim 5, wherein the blocks are time stamped by an externally verifiable source.

9. A data storage management system for storing data in a data storage unit, the data storage management system comprising:
a client device configured to store a block of data in the data storage unit, wherein the client device comprises:
a selection module configured to select a random seed to initialize a secure random number generator;
a computing module configured to compute a secure hash of the block of data to be stored by utilizing a plurality of bytes at one or more addresses specified by a series of numbers from an output of the random number generator;
a storage module configured to store the secure hash of the block of data and the random seed; and
a transmission module configured to transmit to a provider device, the block of data together with a secret key and the secure hash and the random seed pairs; and
a provider device configured to validate a storage challenge identified on a storage token (ST) chain by the provider device, wherein the provider device comprises:
an initializing module configured to initialize an identical random number generator by using the random seed;
a computing module configured to compute the secure hash of the stored data sent by the client device; and
a verification module configured to place the computed secure hash of the block of data on the storage token (ST) chain for verification.

10. The data storage management claimed in claim 9, wherein the storage challenge identified on the ST chain is verified on matching secure hash of a unique identification number of the provider device together with stored secure hash of data sent by the client device.

11. The data storage management system as claimed in claim 9, wherein the ST chain transmits a plurality of storage tokens listed in the storage challenge into the provider device on verification of the storage challenge.

12. The data storage management system as claimed in claim 9, wherein the ST chain returns the storage tokens into the client device on non-verification of the storage challenge.

13. A data storage management system for accessing a data storage unit for retrieving stored data, the data storage management system comprising:
an initializing module configured to initiate, in the client device, a request for accessing a block of data by transmitting a secure hash of the block of data together with a secret key registered when the block of data was stored in the data storage unit;
a verification module configured to verify, in a provider device, the received secure hash of the block of data and the secret key;
a transmission module configured to send, from the provider device to the client device, the block of data encrypted with a new secret key;
a computing module configured to compute, in the client device, a secure hash of the encrypted block of data and placing the computed secure hash with a sum of a plurality of storage tokens on a storage token (ST) chain;
a placement module configured to place, in the provider device, a responding block on the ST chain to hold the secure hash of the block of data with the new secret key to decrypt the data;
a retrieval module configured to retrieve, in the client device, the new secret key that the provider device used to encrypt the block of data sent from the client device;
a decryption module configured to decrypt, in the client device, the block of data; and
a transferring module configured to transfer the storage tokens from the client device to the provider device.

14. The data storage management system as claimed in claim 13, wherein the ST chain executes a plurality of functionalities at a predefined rate to ensure timely performance and prevent denial of one or more service attacks.

15. The data storage management system as claimed in claim 13 further comprises a determination module configured to determine consistency of transactions for one or more double-spend attempts and adding a one or more new blocks to the ST chain.

16. The data storage management system as claimed in claim 13, wherein the blocks are time stamped by an externally verifiable source.
